(19) United States
(12) Patent Application Publication
(10) Pub. No.: US 2023/0019232 A1
(43) Pub. Date: Jan. 19, 2023

(54) METHOD AND SYSTEM FOR GENERATING 3D DIGITAL MODELS

(71) Applicant: RETAIL VR, La Madeleine (FR)

(72) Inventors: Erwan KROTOFF, Nantes (FR); Adrien ZANELLI, Asnieres Sur Seine (FR); Stéphane DUSPASQUIER, Aix En Provence (FR); Grekou YAO, Nantes (FR)

(21) Appl. No.: 17/783,383

(22) PCT Filed: Dec. 14, 2020
(86) PCT No.: PCT/FR2020/052416

§ 371 Date: Jun. 8, 2022

(30) Foreign Application Priority Data
Dec. 12, 2019 (FR) FR1914311

(51) Int. Cl. G06T 17/00; G06T 15/04; G06V 10/764; G06V 10/82

(52) U.S. Cl. CPC G06T 17/00; G06T 15/04; G06V 10/764; G06V 10/82

(57) ABSTRACT

The system comprises a computer server (SRC) and a data storage device (HD), the computer server (SRC) being connected to a data communication network (IT), such as the internet network, and authorizing user access. According to the invention, the system comprises a multi-dimensional type convolutive neural network (AI) ensuring indexing in a database of 3D digital models, using a neural model and a function for selecting at least one three-dimensional digital model (N3D, O3D) having at least one feature in common with an object represented by incoming 2D image data (I2D), the indexing resulting from a classification of incoming 2D image data into different classes of objects as a function of features that are recognized in the incoming 2D image data using the neural model.

The invention relates, in a general manner, to the generation of three-dimensional digital models, referred to as “3D models”. More particularly, the invention relates to a method and to a system for generating three-dimensional digital models.

3D modelling is of great interest for assessing an object in a holistic manner, and for improving the understanding thereof. A 3D model advantageously replaces a large number of two-dimensional images, referred to as “2D images”. Thus, by means of 3D rendering software, the 3D model can easily be manipulated in order to view the object at different angles. The 3D model thus allows for animated presentation of the object by calculating a plurality of images which are displayed successively, typically at a frequency of at least 25 images per second.

By means of “real time” 3D modelling, the 3D model is optimized for real time calculation of images, the rendering of which is performed directly on the display peripheral. This technology offers an increased level of interaction with the user and of control of the animation by said user, thus allowing for increased immersion possibilities and an improved user experience.

The 3D modelling has a significant application in electronic commerce, referred to as “e-commerce”, and has experienced significant development in this field in recent years. The 3D visualization of products on retail websites improves the customers' understanding of the products. By way of a 3D model, the customer can interact with the product, for example by making it pivot or by zooming in on details, which increases their level of engagement towards making a purchase. Animations which make use of 3D models can be easily integrated into the retail website, for example, in order to promote products or draw the attention of the customer.

Currently, most 3D models are created manually using 3D modelling software such as “Blender®”, “3Ds Max®”, “Maya®”, etc. The manual creation of a good-quality 3D model by means of software is an activity which may require a significant amount of work time.

In the prior art, with the aim of improving the situation described above, a three-dimensional modelling method has been proposed which is described by the document EP2381421A2. This method is implemented by computer, and is designed for automatically generating a three-dimensional model of a product from two-dimensional image data. In this method, shape information is extracted from two-dimensional image data, as well as a class of three-dimensional shapes to which the product represented belongs. A three-dimensional graphical outline of the product is then determined from the extracted information. A grid generator generates a three-dimensional grid on the basis of the three-dimensional graphical outline determined and on the class of three-dimensional shapes of the product. The three-dimensional model of the product is obtained by mapping images onto the three-dimensional grid. The images projected onto the three-dimensional grid are extracted from two-dimensional image data of the product.

The document US2019147221A1 describes a method for selecting a three-dimensional digital model on the basis of an provided as an input. An object is identified in the input image, and one or more possible three-dimensional models for a representation of the object are pre-selected in a database. One possible three-dimensional model is finally selected to represent the object in the input image.

The present invention aims to provide a perfectioned method for generating three-dimensional digital models which allows for simple and lower cost generation of three-dimensional digital models which are suitable, in particular, for real-time applications on Internet sites.

According to a first aspect, the invention relates to a method, implemented by computer, for generating three-dimensional digital models in a system for generating three-dimensional digital models for objects represented in two-dimensional images, the method comprising the steps of:

a) assembling a set of diversified data comprising two-dimensional image data and a database of three-dimensional digital models, relating to a plurality of objects;

b) training a convolutive neural network of the multidimensional type using the set of diversified data, so as to obtain a neural model originating from the training;

c) receiving incoming two-dimensional image data representing the object;

d) indexing in the database of three-dimensional digital models, using a neural model and a selection function, at least one three-dimensional digital model having at least one feature in common with an object represented by incoming two-dimensional image data, the indexing resulting from a classification of incoming two-dimensional image data into different classes of objects on the basis of features that are recognized in the incoming two-dimensional image data using the neural model, the recognized features comprising at least a shape feature, a material feature, a texture feature, and/or a visual effect feature;

e) extracting, from the database of three-dimensional digital models, the three-dimensional digital model indexed in step d);

f) adding, to the three-dimensional digital model extracted in step e), at least one of said shape, material, texture or visual effect features recognized in the incoming two-dimensional image data and lacking in the three-dimensional digital model extracted in step e); and

g) providing the three-dimensional digital model obtained in step f) as a three-dimensional digital model of the object represented by the incoming two-dimensional image data.

According to another particular feature, the selection function is based on probabilities of recognition of features in the incoming two-dimensional image data.

According to yet another particular feature, the database of three-dimensional digital models comprises textured and/or non-textured three-dimensional digital models.

According to yet another particular feature, the method also comprises a step of:

h) enriching the set of diversified data with the three-dimensional digital model provided in step g).

According to yet another particular feature, the method also comprises a step of:

i) three-dimensional visualization of a plurality of three-dimensional digital models indexed in step d), and manually selecting one of the visualized three-dimensional digital models as the three-dimensional digital model of the object represented by the incoming two-dimensional image data.

According to yet another particular feature, the method also comprises a step of:

j) automatic selection, based on the selection function, of one three-dimensional digital model from a plurality of three-dimensional digital models indexed in step d), as the three-dimensional digital model of the object represented by the incoming two-dimensional image data.

According to another aspect the invention also relates to a system for generating three-dimensional digital models, comprising at least one computer server and a data storage device associated with the computer server, the computer server being connected to a data communication network and authorizing user access to the system. According to the invention, the system comprises additional means for implementing the method for generating three-dimensional digital models described briefly above, said additional means comprising a convolutive neural network.

The system for generating three-dimensional digital models, of the invention, can be implemented for example in the form of an accessible system in “SAAS” mode (for “Software As a Service”).

According to yet another aspect, the invention also relates to a computer program comprising program code instructions which implement the method for generating three-dimensional digital models, described briefly above, when they are executed by a processor of the computer device.

Other advantages and features of the present invention will emerge more clearly upon reading the detailed description, below, of a plurality of particular embodiments of the invention, with reference to the accompanying drawings, in which:

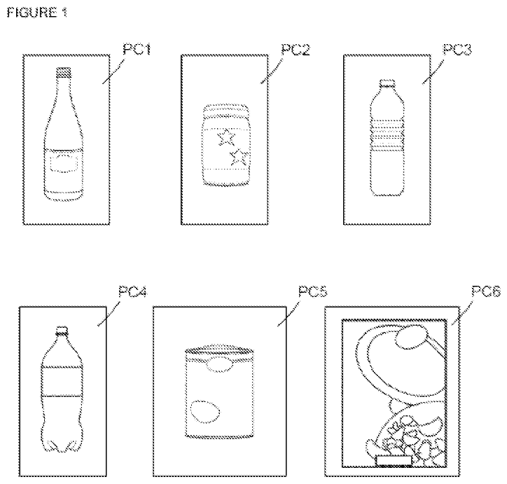

FIG. 1 shows six simplified 2D images of products of different shapes, materials and textures.

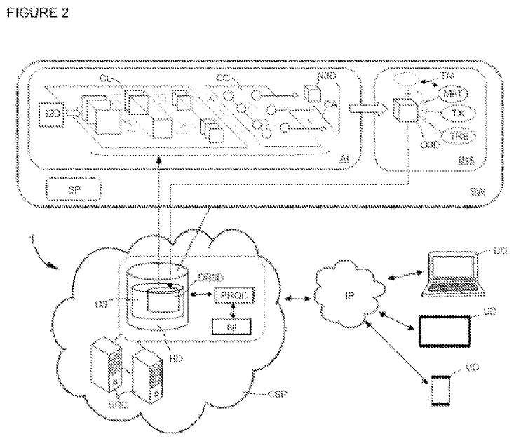

FIG. 2 is a simplified general view of a particular embodiment of the system for generating 3D models according to the invention.

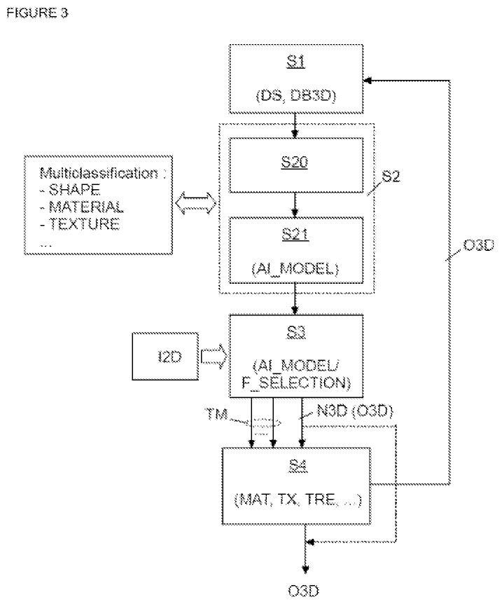

FIG. 3 is a block diagram showing different steps included in the method for generating 3D models according to the invention.

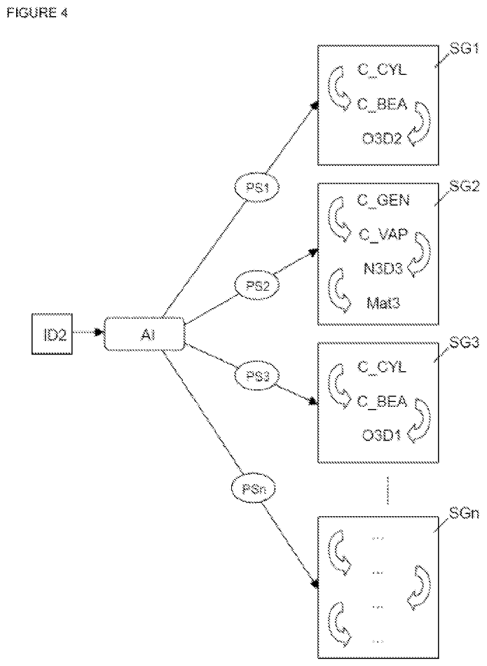

FIG. 4 is a block diagram showing a multi-classification of incoming 2D images, performed in the method for generating 3D models according to the invention.

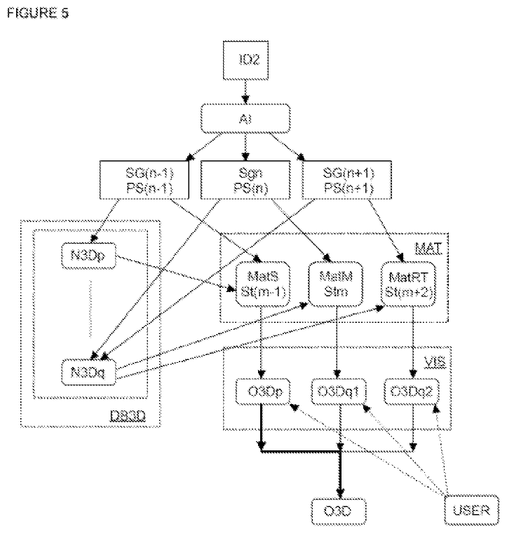

FIG. 5 is a block diagram showing the output of suggestions of 3D models and of processing to be performed on the 3D models in the system for generating 3D models according to the invention.

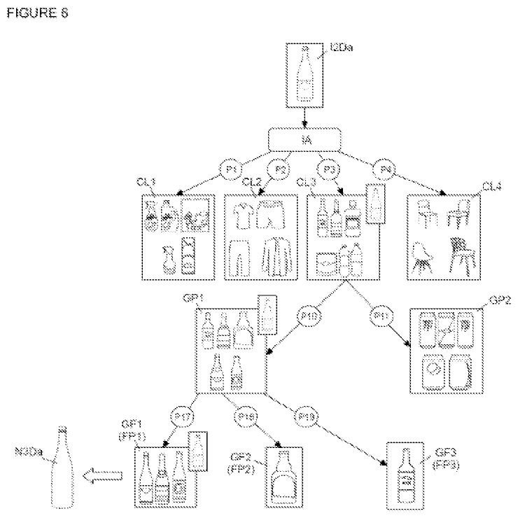

FIG. 6 is a block diagram showing an illustrative example of 3D model suggestion by the artificial intelligence process of the system for generating 3D models according to the invention.

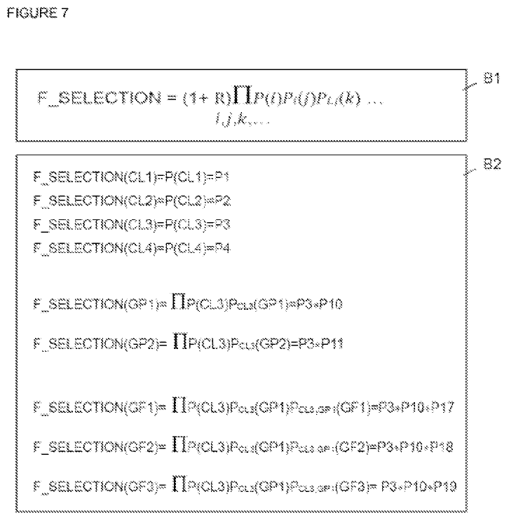

FIG. 7 shows a selection function used by the artificial intelligence process of the system for generating 3D models according to the invention.

In the following description, by way of explanation and in a non-limiting manner, specific details are provided in order to allow for understanding of the technology described. It will be obvious to a person skilled in the art that other embodiments may be implemented outside of the specific details described below. In other cases, the detailed descriptions of well-known methods, devices, techniques, etc. are omitted in order not to complicate the description with unnecessary details.

In the following description of the method and of the system for generating 3D models according to the invention, the objects represented in the images are essentially characterized by shapes, materials, textures and visual effects. The material is defined as being the type of material which is used in the construction of an object. In the design of a 3D object, the material is largely responsible for the visual rendering of the object. The material has particular properties, and is therefore a distinctive feature which makes it possible to distinguish the objects.

Thus, the materials can be classified arbitrarily, for example, into three broad categories, i.e. a category referred to as metals, a category referred to as materials of the ceramics type, and a category referred to as polymers. The category of metals will include for example iron, steel, copper and aluminum. The category of materials of the ceramics type will include for example ceramics and glass. The category of polymers will include for example wood, cardboard, plastics material, leather and rubber.

In a general manner, in 3D modelling, producers of materials typically make it possible to create standard materials having adjustable parameters. A program or script for adding material on a 3D model can control the parameters of a standard material so as to obtain desired visual effects. Thus, for example, the producer of materials contained in a software application of the type Unity3D® authorizes the adjustment of parameters on a standard material, such as the parameters denoted “generic”, “reflectivity” and “transparency”. The “generic” parameter makes it possible to adjust the overall appearance of the object, such as its color for example. The “reflectivity” parameter makes it possible to adjust the reflections of the object, for example, in order to obtain a matte material (diffuse reflection) or a mirror effect (specular reflection). The “transparency” parameter makes it possible to adjust the transparency of the object.

A texture is a 2D image which is applied to a 3D model, generally after application of the material, in order to represent surface details. A texture is for example the 2D image of a logo or a brand label on an object. The operation of adding texture is referred to, by a person skilled in the art, as “texture mapping.” A plurality of textures may be applied to a material in order to obtain a realistic 3D model which reproduces the object in a detailed manner. Reference is then made to “texture multimapping” or “multimapping.”

By way of example, different examples of objects, in the form of commercially available products, are shown schematically in FIG. 1. Thus, FIG. 1 shows six simplified 2D images, denoted PC1 to PC6, representing, respectively, a bottle of cider, a can of beer, a bottle of oil, a bottle of soda, a pot of paint, and a packet of cereal.

A cylindrical shape characterizes the bottle of cider of image PC1, the can of beer of image PC2, the bottle of oil of image PC3, the bottle of soda of image PC4, and the pot of paint of image PC5. The packet of cereal of image PC6 is in turn characterized by a parallelepipedic shape.

A glass material, having high specular reflection, characterizes the bottle of cider of image PC1. A metal material, having high specular reflection, characterizes the can of beer of image PC2. A plastics material, having average specular reflection, characterizes the bottle of oil of image PC3. A plastics material, having average specular reflection, characterizes the bottle of soda of image PC4. A metal material, having a very slight matte material reflection, characterizes the pot of paint of image PC5. A cardboard material, having a very slight matte material reflection, characterizes the packet of cereal of image PC6.

A texture in the form of an image characterizes the bottle of cider of image PC1, the can of beer of image PC2, the bottle of oil of image PC3, the bottle of soda of image PC4, the pot of paint of image PC5, and the packet of cereal of image PC6.

With reference to FIGS. 2 and 7, in the following, by way of example, a particular embodiment 1 of a system for generating 3D models according to the invention will be described.

With reference more particularly to FIG. 2, the system 1 according to the invention for generating 3D models is implemented via a data communication network IP, such as the Internet network, and uses hardware and software resources which are accessible via said network. Thus, in this embodiment, the system 1 uses software and hardware resources available at a cloud computer services provider CSP “cloud service provider”.

The system 1 uses at least one computer server SRC of the cloud computer services provider (CSP). The computer server SRC in particular comprises a processor PROC which communicates with a data storage device HR, typically dedicated to the system 1, and conventional hardware devices such as network interfaces NI and other devices (not shown). The processor PROC comprises one or more central data processing units (not shown) and volatile and non-volatile memories (not shown) for the execution of computer programs.

The system 1 comprises a software system SW for implementing the method for generating 3D models according to the invention. The software system SW is hosted in the data storage device HD which typically comprises one or more hard disks. The method of the invention is implemented in particular by the execution, by the processor PROC, of code instructions of the software system SW.

In this embodiment, the system 1 provides a 3D model generation service of the “SAAS” type which is made accessible to users via the network IP. A software module SP is included in the software system SW and is dedicated to the implementation of said service. Typically, said software module SP may comprise a user interface and/or a programming interface, referred to as “API” (for “Application Programming Interface”), depending on the embodiment of the invention.

The users communicate with the system 1 via their computer systems or devices UD, such as computers, tablets and/or smartphones, connected to the network IP. In order to achieve this, the users may use the Internet browsers of their computer devices UD, or another means, for example a software application which makes use of 3D models for various purposes, and which accesses the service for generating 3D models, of the system 1, via an “API” interface, as indicated above. The users are typically clients of the service for generating 3D models provided by the system 1.

The software system SW comprises a convolutive neural network AI, referred to as the “CNN” network (for “Convolutional Neural Network”), which authorizes the processing of multidimensional data and is capable of deep training, or learning (referred to as “deep learning”). In this case, the convolutive neural network AI is preferably of the type referred to as “supervised,” but not exclusively. The convolutive neural network AI may, for example, be developed by means of a Keras® library, known to a person skilled in the art as being an “open source” code software library.

The convolutive neural network AI provides an artificial intelligence function which is pre-trained to recognize an object represented in a 2D image provided as an input, and to suggest one or more 3D models indexed in a database of 3D models, denoted DB3D in FIG. 2. The 3D model(s) proposed by the artificial intelligence function are the closest to the object represented in the 2D image.

The software system SW also comprises a software module for instantiation and treatment of the INS model, which cooperates with the convolutive neural network AI. The software module INS provides an adjustment function of the 3D model extracted from the database of 3D models by means of the convolutive neural network AI, so as to generate and provide, as an output, a 3D model which corresponds in a detailed manner to the object represented by the 2D image.

Thus, as shown schematically in FIG. 2, image data I2D are provided as an input by a user UD and typically comprise two-dimensional image data 2D, strictly speaking, as well as metadata which describe the 2D image. In the convolutive neural network AI, the image data I2D are first processed by a number of convolution layers CL which make it possible to extract, by successive filtering, features present in the 2D image, such as a shape, a texture, an orientation, etc. Classification layers CC of the convolutive neural network AI then exploit the features extracted by the convolution layers CL, as indexing features, in order to identify, by successive filtering, close classes of 3D models, corresponding to the image data I2D, and to finally suggest a 3D model (or a plurality of models), typically in the form of a non-textured 3D model, denoted N3D in FIG. 2, and material, texture and other features CS to add thereto. The model N3D is the 3D model closest to the image data I2D identified by the convolutive neural network AI in the database of models DB3D. The convolutive neural network AI identifies the features of materials, textures, etc. to grant to the model N3D in order to obtain a 3D model, denoted O3D in FIG. 2, which corresponds in detail to the image data I2D. The features of materials, textures, etc. CA identified are added to the model N3D by means of software programs for processing the 3D model, denoted overall by TM in FIG. 2.

Of course, in the event of the database of models DB3D containing a textured 3D model identified by the network AI and corresponding to the image data I2D, it is this 3D model which will be provided directly, in place of the model N3D mentioned above.

The database of models DB3D typically comprises a library of textured 3D models and a library of non-textured and unorganized 3D models. Said libraries of 3D models of the database of models DB3D are enriched over time. The database of models DB3D forms part of a dataset DS, which is used for training the convolutive neural network AI. The dataset DS essentially comprises the database of models DB3D and 2D image data, and is hosted in this case in the data storage device HD, together with the software library (not shown), for example the Keras® library, of the convolutive neural network AI.

As shown schematically in FIG. 2, the model N3D is processed by the software module for instantiation and for treatment of the model INS in order to produce the finished 3D model, denoted O3D, which is provided to the user UD by the system 1 in response to the image data I2D. The module INS in particular comprises the software programs TM for treatment of the 3D model, which treat the model N3D in order to obtain the model O3D, based on the above-mentioned features CA identified by the convolutive neural network AI. In this embodiment, the software programs TM in particular comprise the programs MAT, TX and TRE which implement, respectively, functions of adding materials such as a metal, bright, matte or other material, adding textures such as an image, and adding special effects such as transparency, a relief, or others. In this case, the programs MAT, TX and TRE are typically scripts in the C# programming language of Microsoft®. Furthermore, the functionalities of a 3D creation software application, such as functionalities of a software application of the type Unity3D®, can also be exploited by the software module INS in order to execute generation of 3D models or particular processing.

The models O3D issued by the software module for instantiation and for treatment of the model INS could also be used by the system 1 in order to enrich the dataset DS comprising the database of models DB3D.

With reference to FIG. 3, the method for generation of 3D models according to the invention essentially comprises four main steps, S1 to S4, for implementing the functioning and processing operations described above.

Step S1 relates to the initial formation and the enrichment of the dataset DS. Step S1 comprises the initial assembly and the organization of image data, in order to obtain a first dataset DS. The dataset DS is then reorganized in order to take account of the enrichment thereof, in particular by the addition of models O3D issued by the software module for instantiation and for treatment of the model INS (cf. step S4). The dataset DS must comprise a rich assembly of highly diversified image data in order to allow for successful training of the convolutive neural network AI. The dataset DS obtained essentially comprises 2D image data and the above-mentioned database of images DB3D containing a library of textured 3D models and a library of non-textured and unorganized 3D models.

Step S2 relates to the training of the convolutive neural network AI. Step S2 includes the sub-steps S20 and S21.

The convolutive neural network AI is configured for multiclassification of images based on a plurality of features, i.e. the shape (denoted SHAPE), the material (denoted MATERIAL), the texture (denoted TEXTURE), and different visual effects and/or effects which can be obtained by image processing, etc. The convolutive neural network AI is also configured to provide a selection function (designated F_SELECTION) for the models N3D and to identify the features CA mentioned above, as indicated above with reference to FIG. 2, on the basis of the recognition probabilities obtained. It will be noted that the configuration of the convolutive neural network AI can be modified depending on the requirements of the application, for example by enlarging the number of classes in the filtering layers of the network AI or by increasing the depth of the branches.

In step S20, the convolutive neural network AI is first trained using the dataset DS initially assembled, and subsequently in order to learn using the new image data by which the dataset DS has been enriched. In order to train the convolutive neural network AI, the dataset DS is divided into three separate sets, i.e. a first set of image data referred to as “training,” a second set of image data referred to as “confirmation,” and a third set of image data referred to as “test.” The first set allows an iterative training algorithm of the network AI to learn the features of each class of images. At each step of the training, the training algorithm performs a confirmation test using the image data of the second set, in order to determine a success rate in the classification. The training algorithm improves the success rate at each iteration by modifying the weighting associated with each neuron of the network AI.

In a general manner, the invention allows for a continuous improvement of the artificial intelligence process. Thus, when a new 2D image is received, the pre-trained convolutive neural network AI provides a prediction file, for example of the CSV type (for “Comma-Separated Values”), containing a list known of 2D images and different associated classes of objects. A 3D model generator makes use of the prediction file in order to create a corresponding 3D model. The 3D model is viewed by an administrator of the system 1 prior to confirmation and storage in the database of models DB3D. In the event of an error of the artificial intelligence process, identified by the administrator, this is corrected by amending the prediction file which can then be reused for the training of the convolutive neural network AI.

The training process is completed in step S21. A neural model AI_MODEL is thus obtained, to which a weighting matrix corresponds which is stored with its final success rate, referred to as “accuracy,” in order to be used by the system 1. The classification of 2D images by the artificial intelligence process is then achieved by matrix operations on the basis of 2D image pixel matrices and the weighting matrix of the neural model AI_MODEL.

In the present invention, the neural model AI_MODEL is of the multi-output type, a plurality of neural sub-models being associated with the various outputs. In the preceding step S20, it will be noted that the training of the convolutive neural network AI can be achieved by jointly training the different neural sub-models in a synchronous manner, or by training them independently, in an asynchronous manner.

Step S3 relates to the use of the neural model AI_MODEL. Image data I2D are provided as an input to the convolutive neural network AI. The neural model AI_MODEL provides the function F_SELECTION and authorizes the indexing of the 3D models, contained in the database of models DB3D, which are closest to the image data I2D provided as the input. In step S3, the closest 3D model(s), non-textured (N3D) or textured (O3D), and if necessary the software programs TM for the above-mentioned processing to be applied to the 3D models, are identified.

According to the method of the invention, multiclassification of the incoming images I2D is performed by the artificial intelligence process of the convolutive neural network AI, in order to determine suggestions of close 3D models and, optionally, processing to be applied thereto by means of software programs TM for 3D model processing.

Thus, in the illustrative example shown in FIG. 4, the convolutive neural network AI outputs suggestions SG1 to SGn for an incoming image I2D, which suggestions follow from the multiclassification performed for said incoming image I2D.

The suggestion SG1 follows from a classification of the incoming image I2D of an object, for example a glass bottle, in a main category of objects C_CYL and a secondary category of objects C_BEA. In this case, the main category C_CYL comprises objects which are cylindrical in shape, and includes the secondary category C_BEA which comprises beer bottles. A 3D model, O3D2, associated with the secondary category C_BEA, is proposed in this suggestion SG1. A probability PS1 for the model O3D2 being the model closest to the glass bottle of the incoming image I2D is linked to the suggestion SG1. The suggestion SG2 follows from a classification of the incoming image I2D of the glass bottle, in a main category of objects C_GEN and a secondary category of objects C_VAP. The main category C_GEN is a generic category comprising different types of objects, and includes the secondary category C_VAP which comprises vaporizers of cylindrical shape. A non-textured 3D model, N3D3, associated with the secondary category C_VAP, is proposed in this suggestion SG2, as well as the application of a material Mat3 to said model N3D3. A probability PS2 for the model N3D3 comprising the material Mat3 being the model closest to the glass bottle of the incoming image I2D is linked to the suggestion SG2. The suggestion SG3 follows from a classification of the incoming image I2D of the glass bottle, in the main category of objects C_CYL and the secondary category of objects C_BEA, mentioned above. A 3D model, O3D1, which is different from the model O3D2 of the suggestion SG1 and is also associated with the secondary category C_BEA, is proposed in this suggestion SG3. A probability PS3 for the model O3D1 being the model closest to the glass bottle of the incoming image I2D is linked to the suggestion SG3. The suggestion having the highest probability is that which is prioritized by the artificial intelligence process. It will be noted that the probabilities mentioned above could be replaced by weightings, percentages, success rates, or others, depending on the embodiments of the invention.

Step S4 relates to the treatments performed on the model N3D by the software module for instantiation and for treatment of the model INS in order to obtain the model O3D which corresponds in detail to the image data I2D. The models O3D obtained during said step S4 could be made use of for enrichment of the dataset DS, as indicated above in relation to step S1.

Different tasks, such as the execution on the model N3D of the above-mentioned programs MAT, TX and TRE, etc. are performed in step S4 by the software module INS. More generally, scripts for modelling and treatment of 3D models, typically in the Microsoft® programming language C#, could be executed here, as well as the functionalities of a software application of the type Unity3D®. The model O3D obtained is stored, preferably but not exclusively, in Collada® format, referred to as “.dae”. Moreover, a 3D visualization interface (not shown) is included in the software module INS for 3D models. Said 3D visualization interface is typically developed in the programming language C#, in an environment of the type Unity3D®.

In the illustrative example shown in FIG. 5, the convolutive neural network AI outputs suggestions SG(n−1), SGn and SG(n+1) for an incoming image I2D, having probabilities PS(n−1), PSn and PS(n+1), respectively. The suggestion SG(n−1) proposes a non-textured 3D model, N3Dp, comprising a standard material MatS to be applied. The suggestions SG(n) and SG(n+1) both propose a non-textured 3D model, N3Dq, comprising, respectively, a matte material MatM and a material having reflection and transparency MatRT. In the software module INS, the program for adding materials MAT comprises scripts St(m−1), Stm and St(m+1) which are dedicated, respectively, to the addition of the materials MatS, MatM and MatRT. The processing performed by the scripts St(m−1), Stm and St(m+1) on the models N3Dp, N3Dq, makes it possible to obtain 3D models, O3Dp, O3Dq1 and O3Dq2, which correspond, respectively, to the suggestions SG(n−1), SGn and SG(n+1). In this example, the three models O3Dp, O3Dq1 and O3Dq2 are presented to the user USER via a 3D visualization interface VIS. The USER is given the possibility of selecting the model retained O3D from the models O3Dp, O3Dq1 and O3Dq2. In the absence of a selection by the user USER, the process retains, as the model O3D, that which is associated with the highest probability. Considering, for example, that the highest probability is PS(n−1), it is the model O3Dp which is retained.

With reference more particularly to FIG. 6, another illustrative example of the artificial intelligence process implemented by the method of the invention for recognizing a product in a 2D image and for suggesting a corresponding 3D model is now described below. As can be seen in FIG. 6, in this illustrative example, the 2D image provided as an input is the image I2Da of a product which is a glass bottle, for example a bottle of cider.

Firstly, the artificial intelligence process, using the neural model AI_MODEL and the suggestion function F_SELECTION, identifies a category of products CL3 which corresponds to the class bottle of image I2Da, from a plurality of categories of products CL1 to CL4. The artificial intelligence process recognizes the glass bottle of image I2Da as belonging to the categories of products CL1 to CL4 with probabilities P1 to P4, respectively. Since the probability P3 is the highest among the probabilities P1 to P4, the category of products CL3 is the one selected as the category to which the glass bottle of image I2Da belongs. In this case, it is essentially the shape of the glass bottle of image I2Da, of the cylindrical type, which has allowed the artificial intelligence process to perform this first selection.

After the glass bottle of image I2Da has been identified as belonging to the category of products CL3, the artificial intelligence process seeks to determine the product of the category CL3 which is closest to the glass bottle of image I2Da. In order to do so, the artificial intelligence process in this case classifies the products of category CL3 into two categories of products GP1 and GP2. The artificial intelligence process recognizes the glass bottle of image I2Da as belonging to the categories of products GP1 to GP2 with probabilities P10 and P11, respectively. Since the probability P10 is higher than the probability P11, the category of products GP1 is the one selected as the category to which the glass bottle of image I2Da belongs. In this case, it is essentially the glass material of the bottle of image I2Da which has allowed the artificial intelligence process to perform this second selection.

The category of products GP1 comprises different glass bottles. In this case, the artificial intelligence process classifies the glass bottles of category GP1 into three categories of products GF1 to GF3, essentially on the basis of the shape of the glass bottles. Three distinct shapes of bottles FP1 to FP3 correspond to the categories of products GF1 to GF3, respectively. The artificial intelligence process recognizes the glass bottle of image I2Da as having the probabilities P17 to P19 of having the bottle shapes FP1 to FP3, respectively. Since the probability P17 is the highest of the probabilities P17 to P19, the bottle shape FP1 is the one selected as the shape of the glass bottle of image I2Da.

A non-textured 3D model, denoted N3Da in FIG. 3, which is stored in the database of models BD3D, corresponds to the category of products GF2, with which the bottle shape FP1 is associated. The model N3Da is indexed, by the artificial intelligence process, to the image I2Da, and is downloaded. The software module for instantiation and for treatment of the model INS resizes the model N3Da in order to make it correspond to the product of the image I2Da, and applies thereto the glass material recognized by the artificial intelligence process, and a texture extracted from the image I2Da. In an embodiment where the module INS incorporates a software application of the type Unity3D®, mentioned above, the model N3Da is loaded into a scene of said software application, in order to apply thereto the material and the texture.

With reference also to FIG. 7, an example of a selection function F_SELECTION which can be used by the artificial intelligence process is now described in the following.

In the function F_SELECTION, represented in block B1 in FIG. 7:
P(i) is the probability of obtaining a node i,
P(j) is the probability of obtaining a node j, knowing that the node i has already been obtained,
Pi,j(k) is the probability of obtaining a node k, knowing that the nodes i and j have already been obtained, and
R is a regularization parameter.

The conditional probabilities Pi,j between the separate nodes are zero.

In order to illustration the application of said selection function F_SELECTION, the example of the artificial intelligence process of FIG. 6 for recognizing a glass bottle in the image I2Da and for suggesting a corresponding 3D model is considered here.

In this example of FIG. 6, the nodes are the categories of products CL1 to CL4, GP1, GP2, and GF1 to GF3. The application of the selection function F_SELECTION for the calculation of the probabilities, where R=0), is set out in detail in block B2 of FIG. 7. The probabilities for the three branches CL3/GP1/GF1, CL3/GP1/GF2 and CL3/GP1/GF3 are given by F_SELECTION(GF1), F_SELECTION(GF2) and F_SELECTION(GF3), respectively. In this example, the probability F_SELECTION(GF1)=P3*P10*P17 of the branch CL3/GP1/GF1 is considered to be higher than the probabilities of the other branches. The artificial intelligence process thus selects the category GF1 and the 3D model N3Da as corresponding to the glass bottle of image I2Da.

Of course, the invention is not limited to the embodiments that have been described here by way of example. Depending on the applications of the invention, a person skilled in the art could make various amendments and variants which are within the scope of the invention.

1. Method implemented by computer for generating three-dimensional digital models (N3D, O3D) in a system for generating three-dimensional digital models (1) for objects represented in two-dimensional images (I2D, I2Da), said method comprising the steps of a) assembling (S1) a set of diversified data (DS) comprising two-dimensional image data and a database of three-dimensional digital models (DB3D), relating to a plurality of objects, b) training (S2) a convolutive neural network (AI) using said set of diversified data (DS), so as to obtain a neural model (AI_MODEL) originating from said training, c) receiving incoming two-dimensional image data (I2D, I2Da) representing one such object, d) indexing (S3) in said database of three-dimensional digital models (DB3D), using said neural model (AI_MODEL) and a selection function (F_SELECTION), at least one three-dimensional digital model (N3D, O3D) having at least one feature (SHAPE, MATERIAL, TEXTURE) in common with said object represented by said incoming two-dimensional image data (I2D, I2Da), said indexing resulting from a classification of said incoming two-dimensional image data into different classes of objects (C_CYL, C_BEA, C_VAP; CL1 to CL4, GP1, GP2, GF1 to GF3) on the basis of features (SHAPE, MATERIAL, TEXTURE) that are recognized in said incoming two-dimensional image data (I2D, I2Da) using said neural model (AI_MODEL), said recognized features comprising at least a shape feature (SHAPE), a material feature (MATERIAL), a texture feature (TEXTURE), and/or a visual effect feature, e) extracting (S3), from said database of three-dimensional digital models (DB3D), said three-dimensional digital model (N3D, O3D) indexed in step d), f) adding (S4), to said three-dimensional digital model (N3D) extracted in step e), at least one of said shape (SHAPE), material (MATERIAL), texture (TEXTURE) or visual effect features recognized in said incoming two-dimensional image data (I2D, I2Da) and lacking in said three-dimensional digital model (N3D) extracted in step e), and g) providing (S3) said three-dimensional digital model (N3D, O3D) obtained in step f) as a three-dimensional digital model (N3D, O3D) of said object represented by said incoming two-dimensional image data (I2D, I2Da).

2. Method according to claim 1, characterized in that said selection function (F_SELECTION) is based on probabilities of recognition (PSn; P1 to P4, P10, P11, P17 to P19) of said features (SHAPE, MATERIAL, TEXTURE) in said incoming two-dimensional image data (I2D, I2Da).

3. Method according to claim 1, characterized in that said database of three-dimensional digital models (DB3D) comprises textured and/or non-textured three-dimensional digital models (N3D, O3D).

4. Method according to claim 1, characterized in that it also comprises a step h) of enriching (S1) said set of diversified data (DS) using said three-dimensional digital model (O3D) provided in step g).

5. Method according to claim 1, characterized in that it also comprises a step i) of three-dimensional visualization (VIS) of a plurality of said three-dimensional digital models (O3Dp, O3Dq1, O3Dq2) indexed in step d).

6. Method according to claim 1, characterized in that it also comprises a step j) of automatic selection (VIS), based on said selection function (F_SELECTION, PS(n−1), PS(n), PS(n+1)), of one such three-dimensional digital model (O3Dp) from a plurality of three-dimensional digital models (O3Dp, O3Dq1, O3Dq2) indexed in step d), as a three-dimensional digital model (O3D) of said object represented by said incoming two-dimensional image data (I2D, I2Da).

7. System (1) for generating three-dimensional digital models, comprising at least one computer server (SRC) and a data storage device (HD) associated with said computer server (SRC), said computer server (SRC) being connected to a data communication network (IP) and authorizing user access (UD) to said system (1), characterized in that it comprises additional means (SW) for implementing the method for generating three-dimensional digital models according to any of claims 1 to 6, said additional means (SW) comprising a convolutive neural network (AI).

8. Computer program comprising program code instructions which implement the method according to claim 1 when they are executed by a processor (PROC) of the computer device (SRC).
